(19) United States
(12) Patent Application Publication
(10) Pub. No.: US 2025/0158025 A1
(43) Pub. Date: May 15, 2025

(54) NEGATIVE ELECTRODE ACTIVE MATERIAL AND METHOD FOR MANUFACTURING THEREOF, NEGATIVE ELECTRODE MIXTURE, AND SECONDARY BATTERY

(71) Applicant: Toyota Jidosha Kabushiki Kaisha, Toyota-shi (JP)

(72) Inventor: Satoshi MIZUTANI, Okazaki-shi (JP)

(73) Assignee: Toyota Jidosha Kabushiki Kaisha, Toyota-shi (JP)

(21) Appl. No.: 18/926,863

(22) Filed: Oct. 25, 2024

(30) Foreign Application Priority Data
Nov. 15, 2023 (JP) 2023-194331
Sep. 10, 2024 (JP) 2024-156728

(51) Int. Cl. H01M 4/36; H01M 4/02; H01M 4/38; H01M 4/587; H01M 10/0525; H01M 10/054

(52) U.S. Cl. CPC H01M 4/364; H01M 4/387; H01M 4/587; H01M 10/0525; H01M 10/054; H01M 2004/021; H01M 2004/027

(57) ABSTRACT

The present disclosure provides a negative electrode active material capable of suppressing volume changes of the negative electrode active material, thereby improving cycle characteristics of a battery and/or suppressing expansion of the negative electrode active material during initial charging. The negative electrode active material 10 of the present disclosure comprises a composite material containing a carbon material 11 and a tin alloy 12. The Tin alloy is an alloy containing tin, and a metal selected from at least one of cobalt, iron, copper, and nickel. An amount of the carbon material is 10% by mass or more and 30% by mass or less, and a half-width of the tin alloy in XRD spectrum is 0.3° or more. The negative electrode active material of the present disclosure has a void 14 of 0.5% by volume or more and 40% by volume or less.

### FIELD

The present disclosure relates to a negative electrode active material and a method for manufacturing thereof, a negative electrode mixture, and a secondary battery.

### BACKGROUND

As disclosed in PTL 1 and 2, for the improvement of the cycle characteristics of a battery, negative electrode materials containing an element capable of generating alloys such as intermetallic compounds with lithium and a carbon material are known.

It is known that when silicon or tin is used as a negative electrode active material, the volume change of the negative electrode active material occurs with the charge and discharge of the battery, thereby deteriorating the cycle characteristics of the battery. In order to suppress this volume change, a technique for forming voids in a negative electrode active material has been developed, as disclosed in PTL 3 and 4.

### CITATION LIST

### Patent Literature

[PTL 1]. PCT International Publication No. WO 2004/100291
[PTL 2]. PCT International Publication No. WO 2004/100293
[PTL 3]. PCT International Publication No. WO 2013/146658
[PTL 4]. Japanese Unexamined Patent Publication (Kokai) No. 2011-249173

### SUMMARY

### Technical Problem

There is room for improvement in suppressing volume changes of a negative electrode active material.

An object of the present disclosure is to provide a negative electrode active material capable of suppressing volume changes of the negative electrode active material, thereby improving cycle characteristics of a battery and/or suppressing expansion of the negative electrode active material during initial charging, and a method for manufacturing thereof, a negative electrode mixture comprising such a negative electrode active material, and a secondary battery comprising such a negative electrode mixture.

### Solution to Problem

The present inventors have discovered that the above object can be achieved by the following means.

### Aspect 1

A negative electrode active material, wherein
the negative electrode active material comprises a composite material containing a carbon material and a tin alloy,
the tin alloy is an alloy containing tin, and a metal selected from at least one of cobalt, iron, copper, and nickel,
an amount of the carbon material is 10% by mass or more and 30% by mass or less,
a half-width of the tin alloy in XRD spectrum is 0.3° or more, and
the negative electrode active material has a void of 0.5% by volume or more and 40% by volume or less.

### Aspect 2

The negative electrode active material according to Aspect 1, wherein
the negative electrode active material further comprises silicon carbide and metallic silicon, an amount of the metallic silicon is 0.1% by mass or more and 15% by mass or less, and
in XRD spectrum, a ratio of a peak intensity of the silicon carbide relative to a peak intensity of the metallic silicon is 1.0 or more.

### Aspect 3

The negative electrode active material according to Aspect 1 or 2, wherein the negative electrode active material further comprises silicon oxide.

### Aspect 4

A negative electrode mixture comprising the negative electrode active material according to any one of Aspects 1 to 3.

### Aspect 5

A secondary battery, wherein
the secondary battery comprises a negative electrode active material layer, and
the negative electrode active material layer contains the negative electrode mixture according to Aspect 4.

### Aspect 6

A method for manufacturing a negative electrode active material according to any one of Aspects 1 to 3, comprising the following steps:
mixing the carbon material, the tin, and the metal by a mechanical alloying method to obtain the composite material;
mixing the composite material, and a metallic silicon and/or a silicon oxide by a mechanical alloying method to obtain a negative electrode active material precursor; and
contacting the negative electrode active material precursor with an alkaline aqueous solution to elute the metallic silicon and/or the silicon oxide, thereby forming the void.

### Advantageous Effects of Invention

According to the present disclosure, a negative electrode active material capable of suppressing volume changes of the negative electrode active material, thereby improving cycle characteristics of a battery and/or suppressing expansion of the negative electrode active material during initial charging, and a method for manufacturing thereof, a negative electrode mixture comprising such a negative electrode active material, and a secondary battery comprising such a negative electrode mixture can be provided.

### BRIEF DESCRIPTION OF DRAWINGS

FIG. 1A is a schematic view showing an example of a composite material manufacturing process of a negative electrode active material of the present disclosure.

FIG. 1B is a schematic view showing an example of a negative electrode active material precursor manufacturing process of a negative electrode active material of the present disclosure.

FIG. 1C is a schematic view showing an example of a void forming process of a negative electrode active material of the present disclosure.

FIG. 2 is a schematic cross-sectional view showing an example of a secondary battery of the present disclosure.

FIG. 3 is a cross-sectional SEM image of the negative electrode active material of the present disclosure relating to the secondary batteries of Example 1 and 2.

### DESCRIPTION OF EMBODIMENTS

Hereinafter, embodiments of the present disclosure will be described in detail. It should be noted that the present disclosure is not limited to the following embodiments, and various modifications can be made thereto within the scope of the disclosure.

<Negative electrode active material>

First, a negative electrode active material according to a first embodiment of the present disclosure will be described. The negative electrode active material of the present disclosure comprises a composite material containing a carbon material and a tin alloy. The tin alloy in the negative electrode active material of the present disclosure is an alloy containing tin, and a metal selected from at least one of cobalt, iron, copper, and nickel. An amount of the carbon material is 10% by mass or more and 30% by mass or less, and a half-width of the tin alloy in XRD spectrum is 0.3° or more. The negative electrode active material of the present disclosure has a void of 0.5% by volume or more and 40% by volume or less.

The present inventors found that in a negative electrode active material comprising a composite material containing a carbon material and a predetermined tin alloy, not merely forming void, but also making an amount of the carbon material and a volume of the void within a predetermined range, and further making a half-width of the tin alloy at a predetermined value or higher to improve the cycle characteristics of a battery.

The reason for this is not intended to be bound by any theory, but it is estimated as follows.

In the negative electrode active material of the present disclosure, a tin alloy can react with lithium ions, sodium ions, and the like, thereby functioning as a negative electrode active material. The negative electrode active material of the present disclosure contains a predetermined amount of carbon material, thereby increasing a half-width of the tin alloy in XRD spectrum, specifically making the tin alloy low crystalline or amorphous. Thus, in the negative electrode active material of the present disclosure, it is thought that by containing the tin alloy and making the tin alloy low crystalline or amorphous, lithium can be smoothly inserted into and desorbed from the tin alloy, and the reaction between the tin alloy and an electrolyte can be suppressed. In addition, when the negative electrode active material of the present disclosure is used together with an electrolytic solution, since the negative electrode active material of the present disclosure contains a carbon material, contact between the electrolytic solution and the tin alloy can be suppressed, thereby an undesirable reaction between these can be suppressed.

In addition to the above, in the negative electrode active material of the present disclosure, by setting a ratio of a volume of voids within a predetermined range, even when the expansion and contraction of the tin alloy occurs due to insertion and desorption of lithium ions or the like, the expansion and contraction of the negative electrode active material as a whole can be suppressed. Therefore, it is considered that, according to the negative electrode active material of the present disclosure, even when charging and discharging are performed, the negative electrode active material is hardly cracked, and as a result, cycle characteristics can be improved.

### <Composite Material>

The negative electrode active material of the present disclosure comprises a composite material containing a carbon material and a tin alloy.

### (Carbon Material)

The composite material contains a carbon material. As described above, when the composite material contains a carbon material, the crystallinity of the negative electrode active material can be reduced, thereby improving the cycle characteristics of the battery. With respect to the present disclosure, the carbon material may be amorphous, and in this case, the carbon material may not participate in the charge and discharge of the battery.

An amount of the carbon material is 10% by mass or more and 30% by mass or less. The amount of the carbon material may be 11% by mass or more, 12% by mass or more, 13% by mass or more, 14% by mass or more, 15% by mass or more, or 16% by mass or more, and may be 28% by mass or less, 26% by mass or less, 24% by mass or less, 22% by mass or less, or 20% by mass or less.

The amount of the carbon material in the negative electrode active material can be quantified, for example, using a carbon/sulfur analyzer by a combustion method.

### (Tin Alloy)

The composite material contains a tin alloy. The tin alloy has the function of absorbing and desorbing diffused ions such as lithium ions and sodium ions, and is therefore involved in the charge and discharge of the battery. The tin alloy produces volume changes with charge and discharge.

The tin alloy is an alloy containing tin, and a metal selected from at least one of cobalt, iron, copper, and nickel. When tin forms an alloy with these metals, cycle properties are improved.

A half-width of the tin alloy in XRD spectrum is 0.3° or more. This half-width may be 0.5° or more, 0.7° or more, 1.0° or more, 1.5° or more, 2.0° or more, or 3.0° or more, and may be 10.0° or less, 8.0° or less, 6.0° or less, or 5.0° or less. XRD spectrum may be, for example, a diffraction peak obtained by X-ray diffraction using CuKα radiation as a characteristic X-ray and a sweep speed of 1°/min. The half-width of the tin alloy in XRD spectrum can be evaluated as the half-width of the peak near 2θ=45°. Further, the half-width of the tin alloy in XRD spectrum can be evaluated in a discharged state, that is, in a state in which a lithium ions or the like are not inserted.

### <Void>

The negative electrode active material of the present disclosure has a void of 0.5% by volume or more and 40% by volume or less. A rate of a volume of the void in the negative electrode active material may be 1.0% by volume or more, 1.5% by volume or more, 2.0% by volume or more, 3.0% by volume or more, 4.0% by volume or more, 5.0% by volume or more, 6.0% by volume or more, 7.0% by volume or more, 8.0% by volume or more, or 9.0% by volume or more, and may be 35% by volume or less, 30% by volume or less, 25% by volume or less, 20% by volume or less, 15% by volume or less, or 10% by volume or less. When the negative electrode active material has the void in such a ratio, volume changes of the tin alloy that accompany the charge and discharge of the battery can be alleviated.

The average diameter of the void may be 1.0 μm or less. The average diameter of the void may be 0.1 μm or more, or 0.2 μm or more, and may be 0.8 μm or less, 0.6 μm or less, or 0.4 μm or less.

The rate of the volume and the average diameter of the void can be measured, for example, by mercury intrusion technique.

### (Silicon Carbide and Metallic Silicon)

The negative electrode active material of the present disclosure may further comprise silicon carbide and metallic silicon. In this case, an amount of metallic silicon may be 0.1% by mass or more and 15% by mass % or less, and in XRD spectrum, a ratio of a peak intensity of the silicon carbide relative to a peak intensity of the metallic silicon may be 1.0 or more. With such a configuration, the cycle characteristics of the battery are further improved. The reason for this is not intended to be bound by any theory, but is considered to be because a predetermined amount of silicon carbide can contribute to suppressing the reaction between the negative electrode active material and the electrolyte.

With respect to the present disclosure, the term “further comprises silicon carbide and metallic silicon” means comprising both silicon carbide and metallic silicon in amounts detectable by a predetermined measurement method. Specifically, regarding silicon carbide, for example, the negative electrode active material can be considered to contain silicon carbide, when it can be observed as a peak in XRD spectrum. Regarding metallic silicon, for example, the negative electrode active material can be considered to contain metallic silicon, when it can be detected by energy dispersive X-ray fluorescence spectroscopy (EDX) and high frequency inductively coupled plasma (ICP) atomic emission spectroscopy.

When the negative electrode active material of the present disclosure further comprise silicon carbide and metallic silicon, an amount of the metallic silicon may be 1.0% or more, 2.0% or more, 3.0% or more, 4.0% or more, or 4.5% or more, and may be 10% or less, 8.0% or less, 7.0% or less, or 6.5% or less.

In XRD spectrum, a rate of a peak intensity of the silicon carbide relative to a peak intensity of metallic silicon may be 2.0 or more, 3.0 or more, 4.0 or more, 5.0 or more, or 5.5 or more, and may be 15 or less, 10 or less, 8.0 or less, or 7.0 or less.

An amount of the silicon carbide (SiC) and the metallic silicon (Si) can be measured for example, by X-ray diffraction (XRD). Specifically, for example, using a peak intensity value of 70°+0.5 in XRD measurement result as background, the value obtained by subtracting the background from a maximum value of 35.2° to 35.7° can be taken as the value of SiC. Similarly, the value obtained by subtracting the background from a maximum value of 47.5° to 48.0° can be taken as the value of Si. The value of SiC divided by the value of Si can be determined as a SiC/Si peak intensity ratio.

### <Silicon Oxide>

The negative electrode active material of the present disclosure may further comprise silicon oxide.

The method for detecting silicon oxide is not particularly limited. For example, when silicon oxide can be detected by infrared absorption method, acid dissolution, and the ICP-AES method, the negative electrode active material can be determined to comprise silicon oxide.

In the context of the present disclosure, “silicon oxide” may refer specifically to silicon dioxide (SiO₂).

### <<Manufacturing Method for Negative Electrode Active Material>>

The method of the present disclosure for manufacturing a negative electrode active material comprises the following steps: mixing the carbon material, the tin, and the metal by a mechanical alloying method to obtain the composite material (a composite material manufacturing step), mixing the composite material and a metallic silicon by a mechanical alloying method to obtain a negative electrode active material precursor (a negative electrode active material precursor manufacturing step), and contacting the negative electrode active material precursor with an alkaline aqueous solution to elute the metallic silicon, thereby forming the void (a void forming step).

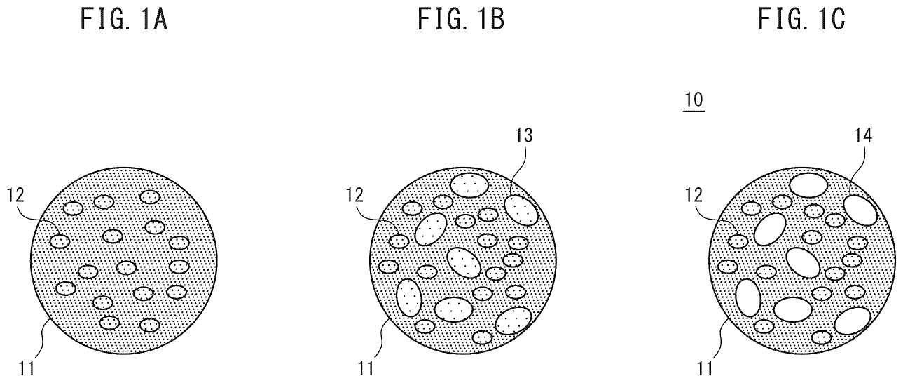

A schematic view of the composite material obtained in the composite material manufacturing process is shown in FIG. 1A, a schematic view of the negative electrode active material precursor obtained in the negative electrode active material precursor manufacturing process is shown in FIG. 1B, and a schematic view of the negative electrode active material 10 obtained in the void forming process is shown in FIG. 1C. In FIG. 1 “11” shows a carbon material, “12” shows a tin alloy, “13” shows metallic silicon, and “14” shows a void.

### <Composite Material Manufacturing Step>

The method of the present disclosure comprises mixing the carbon material, the metal, and the tin by a mechanical alloying method to obtain the composite material.

With respect to the method of the present disclosure, the composition of the tin alloy can be controlled by adjusting the amount used of the metal and the tin.

Examples of the mechanical alloying method include treating the above materials for a prescribed time at a prescribed rotation number by a ball mill under an inert gas atmosphere. For example, by controlling the rotation speed and processing time during processing in this step, the half width of the tin alloy, and the ratio of the volume of the void can be adjusted.

### <Negative Electrode Active Material Precursor Manufacturing Step>

The method of the present disclosure comprises mixing the composite material, and a metallic silicon and/or a silicon oxide by a mechanical alloying method to obtain a negative electrode active material precursor.

As for the mechanical alloying method, the above description regarding the composite material manufacturing process can be referred to. For example, by controlling the rotation speed and processing time during the treatment in this step, the ratio of the volume and average diameter of the void, and the amount of the silicon carbide and the metallic silicon comprised in the negative electrode active material can be adjusted.

### <Void Forming Step>

The method of the present disclosure comprises contacting the negative electrode active material precursor with an alkaline aqueous solution to elute the metallic silicon and/or the silicon oxide, thereby forming the void.

As a method of contacting the negative electrode active material precursor with an alkaline aqueous solution, for example, a method in which the negative electrode active material precursor is immersed in an alkaline aqueous solution and stirred is exemplified. By controlling the immersion and stirring time in this step, the content of silicon carbide and metallic silicon comprised in the negative electrode active material can be controlled.

When metallic silicon is used as a component to be eluted in contact with an alkaline aqueous solution in the void forming step, it is easy to produce a negative electrode active material further containing silicon carbide and metallic silicon.

In the void forming step, silicon oxide may be used as a component that is eluted by contact with an alkaline aqueous solution. Silicon oxide is easily eluted in an alkaline aqueous solution, and therefore easily forms voids in the negative electrode active material. Even if silicon oxide is not completely eluted and remains in the negative electrode active material, that is, even if the negative electrode active material further comprises silicon oxide, silicon oxide does not react with lithium, and therefore a decrease in battery capacity can be suppressed.

In the void forming step, it is also possible to form the void in the negative electrode active material by using a component which is eluted by being brought into contact with an alkaline aqueous solution other than metallic silicon. As such a component, aluminum or the like is exemplified.

### <<Negative Electrode Composite Material>>

The negative electrode mixture of the present disclosure comprises the negative electrode active material of the present disclosure, and optionally comprises a conductive aid and a binder. When the secondary battery of the present disclosure is a solid-state battery, the negative electrode mixture of the present disclosure optionally comprises a solid electrolyte.

### <Negative Electrode Active Material>

For the negative electrode active material, the above description relating to the negative electrode active material of the present disclosure can be referred to.

### <Conductive Aid, Binder and Solid Electrolyte>

The conductive aid, the binder, and the solid electrolyte may be those commonly used in secondary batteries.

### <<Secondary Battery>>

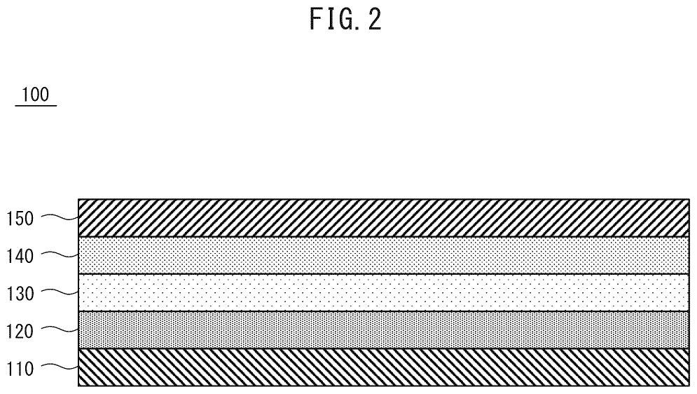

As shown in FIG. 2, the secondary battery 100 of the present disclosure comprises a negative electrode active material layer 120, wherein the negative electrode active material layer contains the negative electrode mixture of the present disclosure. The secondary battery of the present disclosure may comprise a negative electrode current collector 110, a negative electrode active material layer 120 containing a negative electrode mixture of the present disclosure, a separator 130, a positive electrode active material layer 140, and a positive electrode current collector 150.

The secondary battery may be a liquid-based battery containing an electrolytic solution as an electrolyte layer, and may be a solid-state battery having a solid electrolyte layer as an electrolyte layer. The electrolyte layer in a liquid-based battery may be a separator impregnated with an electrolyte. The solid electrolyte layer in a solid-state battery may have the function of a separator. The battery of the present disclosure may be, in particular, a liquid-based battery containing an electrolytic solution as an electrolyte layer. The “solid-state battery” relating to the present disclosure means a battery using at least a solid electrolyte as the electrolyte, and therefore the solid-state battery may use a combination of a solid electrolyte and a liquid electrolyte as the electrolyte. In addition, the solid-state battery of the present disclosure may be an all-solid-state battery, i.e., a battery using only a solid electrolyte as the electrolyte.

Examples of secondary battery is lithium ion battery and sodium ion battery.

### <Negative Electrode Current Collector>

The negative electrode current collector may be composed of known metals or the like that can be used as a negative electrode current collector in a secondary battery.

### <Negative Electrode Active Material Layer>

The negative electrode active material layer contains the negative electrode mixture of the present disclosure. For the negative electrode mixture of the present disclosure, the above description relating to the negative electrode mixture of the present disclosure can be referred to.

### <Separator>

As the separator, those known as separators used in secondary batteries may be used.

When the secondary battery of the present disclosure is a liquid-based battery, the separator may be impregnated with an electrolytic solution to form an electrolyte layer. As the electrolytic solution, a known one may be used as an electrolytic solution used in a secondary battery.

When the secondary battery of the present disclosure is a solid-state battery, the solid electrolyte layer can function as a separator. The solid electrolyte layer contains a solid electrolyte. For the solid electrolyte, the above description regarding the negative electrode mixture of the present disclosure can be referred to.

### <Positive Electrode Active Material Layer>

The positive electrode active material layer contains a positive electrode active material, and optionally contains a conductive aid and a binder. When the secondary battery of the present disclosure is a solid-state battery, the positive electrode active material layer of the present disclosure optionally contains a solid electrolyte.

As the positive electrode active material, a known one may be used as a positive electrode active material used in a secondary battery.

For the conductive aid, the binder, and the solid electrolyte, the above description regarding the negative electrode mixture of the present disclosure can be referred to.

### <Positive Electrode Current Collector>

The positive electrode current collector may be composed of known metals or the like that can be used as a positive electrode current collector in a secondary battery.

### EXAMPLES

### Manufacturing Example 1

### <Production of Negative Electrode Active Material>

### (Composite Material Manufacturing Step)

Raw materials composed of a carbon material, tin, and a metal element forming an alloy with tin was weighed so as to have a desired composition ratio. The total mass of the raw materials was 10 g. 400 g of SUS balls and weighed raw materials were put into a 500 mL container made of chromium steel, which were replaced with argon (Ar) gas and sealed, and treated with mechanical alloying at rotation speed of 250 rpm for 20 hours. Thereby, a composite material was obtained.

### (Negative Electrode Active Material Precursor Manufacturing Step)

After measuring a predetermined amount of metallic silicon, it was put into the above-mentioned container, which was replaced with Ar gas and sealed, and treated with mechanical alloying method at rotation speed of 250 rpm for 1 hour. After the treatment, the material in the container was collected, and classified using a mesh with an opening of 53 μm, then the powder passed through the mesh was collected. Thus, a negative electrode active material precursor was obtained.

### (Void Formation Step)

The obtained negative electrode active material precursor was brought into contact with an alkaline aqueous solution to elute the metallic silicon. Specifically, 5 g of the negative electrode active material precursor was immersed in 500 mL of 2M NaOH solution for 1 hour with stirring, and then subjected to suction filtration. After washing with 5L of ion-exchanged water and filtration, the solution was dried under vacuum at ordinary temperature. Thus, a powdery negative electrode active material was obtained.

### Example 1-1

### <Production of Secondary Ion Battery>

The negative electrode active material of Manufacturing Example 1/acetylene black (AB)/polyvinylidene fluoride (PVdF) were weighed at a mass ratio of 80/15/5, and dispersed in N-methyl-2-pyrrolidone (NMP) to prepare a slurry. This slurry was coated on a copper (Cu) current collector foil, pressed, and then vacuum dried overnight at 120° C. to serve as test electrode. Metallic lithium (Li) foil was used as a counter electrode. As an electrolytic solution, 1M LiPF₆ in EC/DMC/FEC was used. Thus, a coin cell (CR2032) for electrochemical measurement of Example 1-1 was produced.

### Example 2-1

The negative electrode active material of Manufacturing Example 1/AB/PVdF was weighed at a mass ratio of 80/10/10, and dispersed in a NMP to prepare a slurry. This slurry was coated on an aluminum (Al) current collector foil, pressed, and then vacuum dried overnight at 120° C. to serve as test electrode. Metallic sodium (Na) foil was used as a counter electrode. As an electrolytic solution, 1M NaPF₆ in PC was used. Thus, a coin cell (CR2032) for electrochemical measurement of Example 2-1 was generated.

### <<Evaluation>>

### <Confirm of Composition of Tin Alloy>

The composition of the tin alloy was confirmed by quantifying the amount of tin and the metal elements that form an alloy with tin using energy dispersive X-ray fluorescence spectroscopy (EDX) and high frequency inductively coupled plasma (ICP)-atomic emission spectroscopy.

### <Quantification of Carbon Amount>

The amount of carbon in the negative electrode active material was quantified by the combustion method using a carbon/sulfur analyzer.

### <Measurement of Half-Width of Tin Alloy>

The half-width of the tin alloy was measured By X-ray diffractometry (XRD). XRD spectrum was a diffraction peak obtained by X-ray diffraction using CuKα radiation as a characteristic X-ray and a sweep speed of 1°/min.

### <Ratio of Volume and Average Diameter of Void>

The ratio of the volume and the average diameter of the void in the negative electrode active material were measured by the mercury intrusion technique.

### <Capacity Retention Rate>

Capacity retention rate was measured by the following method for each reaction species.

### (Lithium Ion Battery)

Evaluation was performed in voltage range of 0.05V to 2.0V and at a 0.1 C rate. The capacity retention rate was calculated using the initial Li removal capacity as a denominator and the capacity at the time of Li removal reaction after repeated 10 cycles of charging and discharging as a numerator. The evaluation was performed in a constant temperature bath at 25° C.

### (Sodium Ion Battery)

Evaluation was performed in voltage range of 0.05V to 1.5V and at a 0.1 C rate. The capacity retention rate was calculated using the capacity at the time of the first Na removal reaction as a denominator and the capacity at the time of Na removal reaction after repeated 8 cycles of charging and discharging as a molecular. The evaluation was performed in a constant temperature bath at 25° C.

### Example 1-2 to 1-12 and 2-2 to 8-2, and Comparative Example 1-1 to 8-1

Batteries of each example were produced and evaluated in the same manner as in Examples 1-1 and 2-1, except that composition of tin alloy, carbon amount, half-width of tin alloy, and ratio of volume and average diameter of void were changed as shown in Tables 1 to 8.

### Results

The composition of the tin alloy, carbon amount, half-width of tin alloy, ratio of volume and average diameter of void, and capacity retention rate are shown in Tables 1 to 8.

TABLE 1

| | Counter | Composition of | Carbon amount | Half-width of | Ratio of volume | Average diameter | Capacity retention |
|---|---|---|---|---|---|---|---|
| | electrode | tin alloy | [wt %] | tin alloy [°] | of void [%] | of void [μm] | rate [%] |
| Example 1-1 | Li | Co₄₄Sn₅₆ | 16 | 1.5 | 5.2 | 0.2 | 81 |
| Example 1-2 | Li | Co₃₈Sn₆₂ | 16 | 1.5 | 5.3 | 0.2 | 80 |
| Example 1-3 | Li | Co₂₄Sn₇₆ | 16 | 1.5 | 5.1 | 0.2 | 77 |
| Example 1-4 | Li | Fe₄₄Sn₅₆ | 16 | 1.5 | 5 | 0.2 | 79 |
| Example 1-5 | Li | Fe₃₈Sn₆₂ | 16 | 1.5 | 5.2 | 0.2 | 78 |
| Example 1-6 | Li | Fe₂₄Sn₂₆ | 16 | 1.5 | 5.4 | 0.2 | 75 |
| Example 1-7 | Li | Cu₃₅Sn₄₅ | 16 | 1.5 | 5.1 | 0.3 | 71 |
| Example 1-8 | Li | Cu₄₅Sn₅₅ | 16 | 1.5 | 5.5 | 0.3 | 72 |
| Example 1-9 | Li | Cu₃₅Sn₆₅ | 16 | 1.5 | 5.3 | 0.3 | 73 |
| Example 1-10 | Li | Ni₅₀Sn₅₀ | 16 | 1.5 | 5.2 | 0.3 | 70 |
| Example 1-11 | Li | Ni₄₂Sn₃₈ | 16 | 1.5 | 5.5 | 0.3 | 69 |
| Example 1-12 | Li | Ni₃₃Sn₆₇ | 16 | 1.5 | 5.5 | 0.3 | 68 |
| Comparative Example 1-1 | Li | Co₄₄Sn₅₆ | 16 | 1.5 | 0.1 | — | 55 |
| Comparative Example 1-2 | Li | Fe₃₈Sn₆₂ | 16 | 1.5 | 0.1 | — | 51 |
| Comparative Example 1-3 | Li | Cu₄₅Sn₅₅ | 16 | 1.5 | 0.1 | — | 45 |
| Comparative Example 1-4 | Li | Ni₄₂Sn₅₈ | 16 | 1.5 | 0.1 | — | 43 |

TABLE 2

| | Counter | Composition of | Carbon amount | Half-width of | Ratio of volume | Average diameter | Capacity retention |
|---|---|---|---|---|---|---|---|
| | electrode | tin alloy | [wt %] | tin alloy [°] | of void [%] | of void [μm] | rate [%] |
| Example 2-1 | Na | Co₃₈Sn₆₂ | 16 | 1.5 | 5.2 | 0.2 | 60 |
| Example 2-2 | Na | Co₂₄Sn₇₆ | 16 | 1.5 | 5.3 | 0.2 | 61 |
| Example 2-3 | Na | Co₁₆Sn₈₄ | 16 | 1.5 | 5.1 | 0.2 | 57 |
| Example 2-4 | Na | Fe₃₄Sn₆₂ | 16 | 1.5 | 5 | 0.2 | 59 |
| Example 2-5 | Na | Fe₂₄Sn₇₆ | 16 | 1.5 | 5.2 | 0.2 | 58 |
| Example 2-6 | Na | Fe₁₅Sn₈₅ | 16 | 1.5 | 5.4 | 0.2 | 55 |
| Example 2-7 | Na | Cu₄₅Sn₅₅ | 16 | 1.5 | 5.1 | 0.3 | 51 |
| Example 2-8 | Na | Cu₃₅Sn₆₅ | 16 | 1.5 | 5.5 | 0.3 | 52 |
| Example 2-9 | Na | Cu₃₀Sn₇₀ | 16 | 1.5 | 5.3 | 0.3 | 54 |
| Example 2-10 | Na | Ni₄₂Sn₅₈ | 16 | 1.5 | 5.2 | 0.3 | 51 |
| Example 2-11 | Na | Ni₃₃Sn₆₇ | 16 | 1.5 | 5.5 | 0.3 | 50 |
| Example 2-12 | Na | Ni₃₈Sn₇₂ | 16 | 1.5 | 5.5 | 0.3 | 52 |
| Comparative Example 2-1 | Na | Co₂₄Sn₇₆ | 16 | 1.5 | 0.1 | — | 25 |
| Comparative Example 2-2 | Na | Fe₂₄Sn₇₆ | 16 | 1.5 | 0.1 | — | 11 |
| Comparative Example 2-3 | Na | Cu₃₅Sn₆₅ | 16 | 1.5 | 0.1 | — | 20 |
| Comparative Example 2-4 | Na | Ni₃₃Sn₆₇ | 16 | 1.5 | 0.1 | — | 19 |

As shown in Tables 1 and 2, in the batteries of the Comparative Examples in which no void was formed, the capacity retention rate was lower than that of the batteries of the Examples.

TABLE 3

| | Counter | Composition of | Carbon amount | Half-width of | Ratio of volume | Average diameter | Capacity retention |
|---|---|---|---|---|---|---|---|
| | electrode | tin alloy | [wt %] | tin alloy [°] | of void [%] | of void [μm] | rate [%] |
| Example 1-2 | Li | Co₃₈Sn₆₂ | 16 | 1.5 | 5.3 | 0.2 | 80 |
| Example 3-1 | Li | Co₃₈Sn₆₂ | 11 | 1.3 | 5 | 0.3 | 68 |
| Example 3-2 | Li | Co₃₈Sn₆₂ | 28 | 1.8 | 5.5 | 0.4 | 78 |
| Example 1-5 | Li | Fe₃₈Sn₆₂ | 16 | 1.5 | 5.2 | 0.2 | 78 |
| Example 3-3 | Li | Fe₃₈Sn₆₂ | 11 | 1.3 | 5.2 | 0.3 | 70 |
| Example 3-4 | Li | Fe₃₈Sn₆₂ | 27 | 1.9 | 5.2 | 0.5 | 75 |
| Comparative Example 3-1 | Li | Co₃₈Sn₆₂ | 5 | 0.9 | 5.3 | 0.2 | 48 |
| Comparative Example 3-2 | Li | Co₃₈Sn₆₂ | 35 | 1.5 | 5.3 | 0.5 | 51 |
| Comparative Example 3-3 | Li | Fe₃₈Sn₆₂ | 5 | 1.5 | 5.2 | 0.2 | 38 |
| Comparative Example 3-4 | Li | Fe₃₈Sn₆₂ | 35 | 1.5 | 5.2 | 0.6 | 50 |

TABLE 4

| | Counter | Composition of | Carbon amount | Half-width of | Ratio of volume | Average diameter | Capacity retention |
|---|---|---|---|---|---|---|---|
| | electrode | tin alloy | [wt %] | tin alloy [°] | of void [%] | of void [μm] | rate [%] |
| Example 2-2 | Na | Co₂₄Sn₇₆ | 16 | 1.5 | 5.3 | 0.2 | 61 |
| Example 4-1 | Na | Co₂₄Sn₇₆ | 12 | 1.2 | 5.3 | 0.2 | 58 |
| Example 4-2 | Na | Co₂₄Sn₇₆ | 27 | 1.9 | 5.3 | 0.4 | 57 |
| Example 2-5 | Na | Fe₂₄Sn₇₆ | 16 | 1.5 | 5.2 | 0.2 | 58 |
| Example 4-3 | Na | Fe₂₄Sn₇₆ | 11 | 1.3 | 5.2 | 0.2 | 55 |
| Example 4-4 | Na | Fe₂₄Sn₇₆ | 28 | 1.8 | 5.2 | 0.4 | 52 |
| Comparative Example 4-1 | Na | Co₂₄Sn₇₆ | 6 | 0.8 | 5.3 | 0.2 | 11 |
| Comparative Example 4-2 | Na | Co₂₄Sn₇₆ | 35 | 1.8 | 5.3 | 0.5 | 5 |
| Comparative Example 4-3 | Na | Fe₂₄Sn₇₆ | 7 | 0.7 | 5.2 | 0.2 | 16 |
| Comparative Example 4-4 | Na | Fe₂₄Sn₇₆ | 34 | 1.9 | 5.2 | 0.6 | 13 |

As shown in Tables 3 and 4, in the batteries of the Comparative Examples in which carbon amount was outside the range of the present disclosure, the capacity retention rate was lower than that of the batteries of the Examples.

TABLE 5

| | Counter | Composition of | Carbon amount | Half-width of | Ratio of volume | Average diameter | Capacity retention |
|---|---|---|---|---|---|---|---|
| | electrode | tin alloy | [wt %] | tin alloy [°] | of void [%] | of void [μm] | rate [%] |
| Example 5-1 | Li | Co₃₈Sn₆₂ | 16 | 0.7 | 5.2 | 0.2 | 74 |
| Example 1-2 | Li | Co₃₈Sn₆₂ | 16 | 1.5 | 5.3 | 0.2 | 80 |
| Example 5-2 | Li | Co₃₈Sn₆₂ | 16 | 3 | 5.4 | 0.2 | 81 |
| Example 5-3 | Li | Fe₃₈Sn₆₂ | 16 | 0.8 | 5.3 | 0.2 | 71 |
| Example 1-5 | Li | Fe₃₈Sn₆₂ | 16 | 1.5 | 5.2 | 0.2 | 78 |
| Example 5-4 | Li | Fe₃₈Sn₆₂ | 16 | 3 | 5.2 | 0.2 | 78 |
| Comparative Example 5-1 | Li | Co₃₈Sn₆₂ | 16 | 0.2 | 5.2 | 0.2 | 30 |
| Comparative Example 5-2 | Li | Fe₃₈Sn₆₂ | 16 | 0.2 | 5.2 | 0.2 | 24 |

TABLE 6

| | Counter | Composition of | Carbon amount | Half-width of | Ratio of volume | Average diameter | Capacity retention |
|---|---|---|---|---|---|---|---|
| | electrode | tin alloy | [wt %] | tin alloy [°] | of void [%] | of void [μm] | rate [%] |
| Example 6-1 | Na | Co₁₆Sn₈₄ | 16 | 0.7 | 5.1 | 0.2 | 53 |
| Example 2-3 | Na | Co₁₆Sn₈₄ | 16 | 1.55 | 5.1 | 0.2 | 57 |
| Example 6-2 | Na | Co₁₆Sn₈₄ | 16 | 3.1 | 5.3 | 0.2 | 58 |
| Example 6-3 | Na | Fe₁₅Sn₈₅ | 16 | 0.7 | 5.1 | 0.2 | 51 |
| Example 2-6 | Na | Fe₁₅Sn₈₅ | 16 | 1.5 | 5.4 | 0.2 | 55 |
| Example 6-4 | Na | Fe₁₅Sn₈₅ | 16 | 3.2 | 5.2 | 0.2 | 56 |
| Comparative Example 6-1 | Na | Co₁₆Sn₈₄ | 16 | 0.2 | 5.1 | 0.2 | 12 |
| Comparative Example 6-2 | Na | Fe₁₅Sn₈₅ | 16 | 0.2 | 5.1 | 0.2 | 15 |

As shown in Tables 5 and 6, in the batteries of the Comparative Examples in which the half-width of the tin alloy was outside the range of the present disclosure, the capacity retention rate was lower than that of the batteries of the Examples.

TABLE 7

| | Counter | Composition of | Carbon amount | Half-width of | Ratio of volume | Average diameter | Capacity retention |
|---|---|---|---|---|---|---|---|
| | electrode | tin alloy | [wt %] | tin alloy [°] | of void [%] | of void [μm] | rate [%] |
| Example 7-1 | Li | Co₄₄Sn₅₆ | 16 | 1.5 | 1.5 | 0.2 | 65 |
| Example 1-1 | Li | Co₄₄Sn₅₆ | 16 | 1.5 | 5.2 | 0.2 | 81 |
| Example 7-2 | Li | Co₄₄Sn₅₆ | 16 | 1.5 | 27 | 0.8 | 76 |
| Comparative Example 1-1 | Li | Co₄₄Sn₅₆ | 16 | 1.5 | 0.1 | — | 55 |
| Comparative Example 7-1 | Li | Co₄₄Sn₅₆ | 16 | 1.5 | 46 | 1.2 | 45 |

TABLE 8

| | Counter | Composition | Carbon | Half-width of | Ratio of volume | Average diameter | Capacity retention |
|---|---|---|---|---|---|---|---|
| | electrode | of tin alloy | amount [wt %] | tin alloy [°] | of void [%] | of void [μm] | rate [%] |
| Example 8-1 | Na | Fe₂₄Sn₇₆ | 16 | 1.5 | 2.5 | 0.2 | 46 |
| Example 2-5 | Na | Fe₂₄Sn₇₆ | 16 | 1.5 | 5.2 | 0.2 | 58 |
| Example 8-2 | Na | Fe₂₄Sn₇₆ | 16 | 1.5 | 26 | 0.7 | 57 |
| Comparative Example 2-2 | Na | Fe₂₄Sn₇₆ | 16 | 1.5 | 0.1 | — | 11 |
| Comparative Example 8-1 | Na | Fe₂₄Sn₇₆ | 16 | 1.5 | 45 | 1.5 | 18 |

As shown in Tables 7 and 8, in the batteries of the Comparative Examples in which the ratio of the volume of the void was outside the range of the present disclosure, the capacity retention rate was lower than that of the batteries of the Examples.

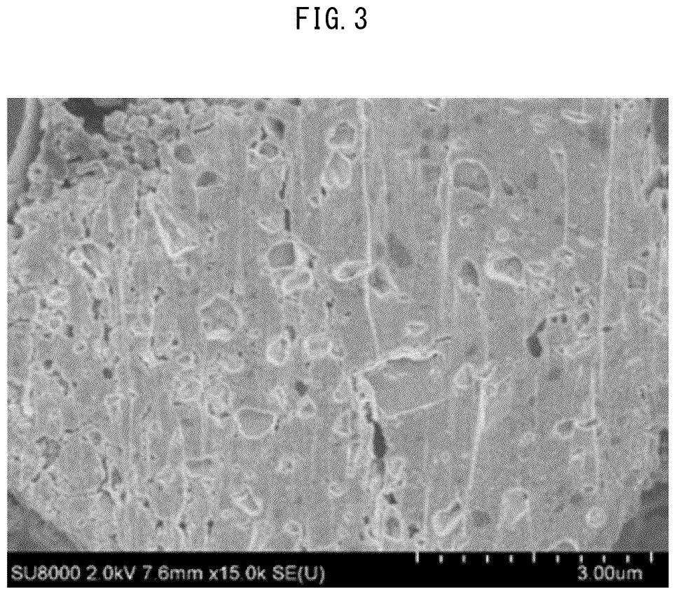

FIG. 3 shows a cross-sectional SEM image of the negative electrode active material of the battery of Example 1-2. As shown in FIG. 3, it was confirmed that the voids are formed in the negative electrode active material.

### Manufacturing Example 2

A negative electrode active material was produced in the same manner as in Manufacturing Example 1 except that: in the composite material manufacturing step, the total mass of the raw materials was 15 g, and the mechanical alloying process was performed at a rotation speed of 275 rpm for 22 hours; in the negative electrode active material precursor manufacturing step, the mechanical alloying method was performed at a rotation speed of 280 rpm for 3 hours; and in the void forming step, the immersion and stirring time was 3 hours.

### Examples 9-1 and 10-1

Batteries of Examples 9-1 and 10-1 were produced in the same manner as Examples 1-1 and 2-1 except that the negative electrode active material of Manufacturing Example 2 was used. It is noted that Examples 1-1 and 9-1, and Examples 2-1 and 10-1 correspond to each other.

### <<Evaluation>>

### <Quantification of Silicon Carbide and Metallic Silicon>

The amount of silicon carbide (SiC) and metallic silicon (Si) was quantified by X-ray diffractometry (XRD). Specifically, using a peak intensity value of 70°±0.5 in XRD measurement result as background, the value obtained by subtracting the background from a maximum value of 35.2° to 35.7° was taken as the value of SiC. Similarly, the value obtained by subtracting the background from a maximum value of 47.5° to 48.0° was taken as the value of Si. The value of SiC divided by the value of Si was determined as a SiC/Si peak intensity ratio.

Other evaluations were performed in the same manner as above.

### Examples 9-2 to 9-12 and 10-2 to 18-3, and Comparative Examples 9-1 to 18-1

Batteries of each example were produced and evaluated in the same manner as Examples 9-1 and 10-1, except that composition of tin alloy, carbon amount, Si amount, SiC/Si peak intensity ratio, half-width of tin alloy, and ratio of volume of void was changed as shown in Tables 9 to 18.

### Results

Composition of tin alloy, carbon amount, Si amount, SiC/Si peak intensity ratio, half-value width of tin alloy, ratio of volume of voids, and capacity retention rate are shown in Tables 9 to 18.

TABLE 9

| | Counter | Composition of | Carbon amount | Si Amount | | Half-width of | Ratio of volume | Capacity retention |
|---|---|---|---|---|---|---|---|---|
| | electrode | tin alloy | [wt %] | [wt %] | SiC/Si | tin alloy [°] | of void [%] | rate [%] |
| Example 9-1 | Li | Co₄₄Sn₅₆ | 16 | 6.3 | 6.5 | 1.5 | 5.2 | 83 |
| Example 9-2 | Li | Co₃₈Sn₆₂ | 16 | 6.3 | 6.2 | 1.5 | 5.3 | 82 |
| Example 9-3 | Li | Co₂₄Sn₇₆ | 16 | 6.2 | 6 | 1.5 | 5.1 | 79 |
| Example 9-4 | Li | Fe₄₄Sn₅₆ | 16 | 6.1 | 6.2 | 1.5 | 5 | 81 |
| Example 9-5 | Li | Fe₃₈Sn₆₂ | 16 | 6.2 | 6.1 | 1.5 | 5.2 | 80 |
| Example 9-6 | Li | Fe₂₄Sn₇₆ | 16 | 6 | 5.9 | 1.5 | 5.4 | 77 |
| Example 9-7 | Li | Cu₅₅Sn₄₅ | 16 | 5 | 6.2 | 1.5 | 5.1 | 74 |
| Example 9-8 | Li | Cu₄₅Sn₅₅ | 16 | 4.9 | 6.1 | 1.5 | 5.5 | 75 |
| Example 9-9 | Li | Cu₃₅Sn₆₅ | 16 | 4.8 | 6.2 | 1.5 | 5.3 | 75 |
| Example 9-10 | Li | Ni₅₀Sn₅₀ | 16 | 5.3 | 6 | 1.5 | 5.2 | 75 |
| Example 9-11 | Li | Ni₄₂Sn₅₈ | 16 | 5.2 | 5.9 | 1.5 | 5.5 | 73 |
| Example 9-12 | Li | Ni₃₃Sn₆₇ | 16 | 5.3 | 5.8 | 1.5 | 5.5 | 71 |
| Comparative Example 9-1 | Li | Co₄₄Sn₅₆ | 16 | 5.3 | 0.8 | 1.5 | 5.2 | 30 |
| Comparative Example 9-2 | Li | Fe₃₈Sn₆₂ | 16 | 5 | 0.7 | 1.5 | 5.1 | 41 |
| Comparative Example 9-3 | Li | Cu₄₅Sn₅₅ | 16 | 5.2 | 0.6 | 1.5 | 5.1 | 45 |
| Comparative Example 9-4 | Li | Ni₄₂Sn₅₈ | 16 | 5.2 | 0.6 | 1.5 | 5.1 | 43 |

As shown in Table 9, when the negative electrode active material further comprised silicon carbide and metallic silicon, in the batteries of the Comparative Examples in which the SiC/Si peak intensity ratio was outside the range of the present disclosure, the capacity retention rate was lower than that of the batteries of the Examples.

TABLE 10

| | Counter | Composition of | Carbon amount | Si Amount | | Half-width of | Ratio of volume | Capacity retention |
|---|---|---|---|---|---|---|---|---|
| | electrode | tin alloy | [wt %] | [wt %] | SiC/Si | tin alloy [°] | of void [%] | rate [%] |
| Example 10-1 | Na | Co₃₈Sn₆₂ | 16 | 6.3 | 6.2 | 1.5 | 5.2 | 65 |
| Example 10-2 | Na | Co₂₄Sn₇₆ | 16 | 6.2 | 6 | 1.5 | 5.3 | 66 |
| Example 10-3 | Na | Co₁₆Sn₈₄ | 16 | 6.1 | 6.2 | 1.5 | 5.1 | 62 |
| Example 10-4 | Na | Fe₃₈Sn₆₂ | 16 | 6.2 | 6.1 | 1.5 | 5 | 64 |
| Example 10-5 | Na | Fe₂₄Sn₇₆ | 16 | 6 | 5.9 | 1.5 | 5.2 | 64 |
| Example 10-6 | Na | Fe₁₅Sn₈₅ | 16 | 6.3 | 6 | 1.5 | 5.4 | 60 |
| Example 10-7 | Na | Cu₄₅Sn₅₅ | 16 | 4.9 | 6.1 | 1.5 | 5.1 | 57 |
| Example 10-8 | Na | Cu₃₅Sn₆₅ | 16 | 4.8 | 6.2 | 1.5 | 5.5 | 58 |
| Example 10-9 | Na | Cu₃₀Sn₇₀ | 16 | 4.7 | 6.1 | 1.5 | 5.3 | 59 |
| Example 10-10 | Na | Ni₄₂Sn₅₈ | 16 | 5.2 | 5.9 | 1.5 | 5.2 | 59 |
| Example 10-11 | Na | Ni₃₃Sn₆₇ | 16 | 5.3 | 5.8 | 1.5 | 5.5 | 57 |
| Example 10-12 | Na | Ni₃₈Sn₇₂ | 16 | 5.1 | 5.7 | 1.5 | 5.5 | 59 |
| Comparative Example 10-1 | Na | Co₂₄Sn₇₆ | 16 | 5.3 | 0.6 | 1.5 | 0.3 | 30 |
| Comparative Example 10-2 | Na | Fe₂₄Sn₇₆ | 16 | 5 | 0.4 | 1.5 | 0.3 | 17 |
| Comparative Example 10-3 | Na | Cu₃₅Sn₆₅ | 16 | 5.2 | 0.3 | 1.5 | 0.3 | 23 |
| Comparative Example 10-4 | Na | Ni₃₃Sn₆₇ | 16 | 5.2 | 0.4 | 1.5 | 0.3 | 27 |

As shown in Table 10, even when the negative electrode active material further comprised silicon carbide and metallic silicon, in the battery of the Comparative Example in which no void was formed, the capacity retention rate was lower than that of the battery of the Example.

TABLE 11

| | Counter | Composition of | Carbon amount | Si Amount | | Half-width of | Ratio of volume | Capacity retention |
|---|---|---|---|---|---|---|---|---|
| | electrode | tin alloy | [wt %] | [wt %] | SiC/Si | tin alloy [°] | of void [%] | rate [%] |
| Example 9-2 | Li | Co₃₈Sn₆₂ | 16 | 6.3 | 6.2 | 1.5 | 5.3 | 82 |
| Example 11-1 | Li | Co₃₈Sn₆₂ | 11 | 6 | 5.7 | 1.3 | 5 | 72 |
| Example 11-2 | Li | Co₃₈Sn₆₂ | 28 | 6.2 | 6 | 1.8 | 5.5 | 81 |
| Example 9-5 | Li | Fe₃₈Sn₆₂ | 16 | 6.2 | 6.1 | 1.5 | 5.2 | 80 |
| Example 11-3 | Li | Fe₃₈Sn₆₂ | 11 | 6 | 6.4 | 1.3 | 5.2 | 77 |
| Example 11-4 | Li | Fe₃₈Sn₆₂ | 27 | 6.2 | 6.1 | 1.9 | 5.2 | 82 |
| Comparative Example 11-1 | Li | Co₃₈Sn₆₂ | 5 | 6 | 6.1 | 0.9 | 5.3 | 50 |
| Comparative Example 11-2 | Li | Fe₃₈Sn₆₂ | 5 | 6.2 | 5.8 | 1.5 | 5.2 | 42 |

TABLE 12

| | Counter | Composition of | Carbon amount | Si Amount | | Half-width of | Ratio of volume | Capacity retention |
|---|---|---|---|---|---|---|---|---|
| | electrode | tin alloy | w1%] | wt %] | SiC/Si | tin alloy [°] | of void [%] | rate [%] |
| Example 10-2 | Na | Co₂₄Sn₇₆ | 16 | 6.2 | 6 | 1.5 | 5.3 | 66 |
| Example 12-1 | Na | Co₂₄Sn₇₆ | 12 | 6 | 5.8 | 1.2 | 5.3 | 60 |
| Example 12-2 | Na | Co₂₄Sn₇₆ | 27 | 6.3 | 6.5 | 1.9 | 5.3 | 59 |
| Example 10-5 | Na | Fe₂₄Sn₇₆ | 16 | 6 | 5.9 | 1.5 | 5.2 | 64 |
| Example 12-3 | Na | Fe₂₄Sn₇₆ | 11 | 6.4 | 5.2 | 1.3 | 5.2 | 58 |
| Example 12-4 | Na | Fe₂₄Sn₇₆ | 28 | 6.3 | 6.3 | 1.8 | 5.2 | 55 |
| Comparative Example 12-1 | Na | Co₂₄Sn₇₆ | 6 | 5.3 | 3.1 | 0.4 | 5.3 | 12 |
| Comparative Example 12-2 | Na | Fe₂₄Sn₇₆ | 7 | 5.1 | 3.5 | 0.4 | 5.2 | 15 |

As shown in Tables 11 and 12, even when the negative electrode active material further comprised silicon carbide and metallic silicon, in the batteries of the Comparative Examples in which carbon amount was outside the range of the present disclosure, the capacity retention rate was lower than that of the batteries of the Examples.

TABLE 13

| | Counter | Composition of | Carbon amount | Si Amount | | Half-width of | Ratio of volume | Capacity retention |
|---|---|---|---|---|---|---|---|---|
| | electrode | tin alloy | [wt %] | [wt %] | SiC/Si | tin alloy [°] | of void [%] | rate [%] |
| Example 13-1 | Li | Co₃₈Sn₆₂ | 16 | 6.2 | 6.1 | 0.8 | 5.2 | 75 |
| Example 9-2 | Li | Co₃₈Sn₆₂ | 16 | 6.3 | 6.2 | 1.5 | 5.3 | 82 |
| Example 13-2 | Li | Co₃₈Sn₆₂ | 16 | 6.4 | 6.4 | 3.3 | 5.4 | 83 |
| Example 13-3 | Li | Fe₃₈Sn₆₂ | 16 | 6.5 | 6.2 | 0.9 | 5.3 | 72 |
| Example 9-5 | Li | Fe₃₈Sn₆₂ | 16 | 6.2 | 6.1 | 1.5 | 5.2 | 81 |
| Example 13-4 | Li | Fe₃₈Sn₆₂ | 16 | 6.1 | 6.2 | 3.2 | 5.2 | 79 |
| Comparative Example 13-1 | Li | Co₃₈Sn₆₂ | 16 | 6.1 | 6.2 | 0.2 | 5.2 | 34 |
| Comparative Example 13-2 | Li | Fe₃₈Sn₆₂ | 16 | 6.4 | 6.2 | 0.2 | 5.2 | 26 |

TABLE 14

| | Counter | Composition of | Carbon amount | Si Amount | | Half-width of | Ratio of volume | Capacity retention |
|---|---|---|---|---|---|---|---|---|
| | electrode | tin alloy | [wt %] | [wt %] | SiC/Si | tin alloy [°] | of void [%] | rate [%] |
| Example 14-1 | Na | Co₁₆Sn₈₄ | 16 | 6.3 | 6.2 | 0.6 | 5.1 | 58 |
| Example 10-3 | Na | Co₁₆Sn₈₄ | 16 | 6.1 | 6.2 | 1.5 | 5.1 | 62 |
| Example 14-2 | Na | Co₁₆Sn₈₄ | 16 | 6.1 | 6.2 | 3.4 | 5.3 | 64 |
| Example 14-3 | Na | Fe₁₅Sn₈₅ | 16 | 6.4 | 6.5 | 0.6 | 5.1 | 55 |
| Example 10-6 | Na | Fe₁₅Sn₈₅ | 16 | 6.3 | 6 | 1.5 | 5.4 | 60 |
| Example 14-4 | Na | Fe₁₅Sn₈₅ | 16 | 6.2 | 6.4 | 3.2 | 5.2 | 59 |
| Comparative Example 14-1 | Na | Co₁₆Sn₈₄ | 16 | 6.2 | 6.2 | 0.2 | 5.1 | 18 |
| Comparative Example 14-2 | Na | Fe₁₅Sn₈₅ | 16 | 6.1 | 6.4 | 0.2 | 5.1 | 19 |

As shown in Tables 13 and 14, even when the negative electrode active material further comprised silicon carbide and metallic silicon, in the batteries of the Comparative Examples in which the half-width of the tin alloy was outside the range of the present disclosure, the capacity retention rate was lower than that of the batteries of the Examples.

TABLE 15

| | Counter | Composition of | Carbon amount | Si Amount | | Half-width of | Ratio of volume | Capacity retention |
|---|---|---|---|---|---|---|---|---|
| | electrode | tin alloy | [wt %] | [wt %] | SiC/Si | tin alloy [°] | of void [%] | rate [%] |
| Example 15-1 | Li | Co₄₄Sn₅₆ | 16 | 6.2 | 6.2 | 1.3 | 1.5 | 70 |
| Example 9-1 | Li | Co₄₄Sn₅₆ | 16 | 6.3 | 6.5 | 1.5 | 5.2 | 83 |
| Example 15-2 | Li | Co₄₄Sn₅₆ | 16 | 6.2 | 6.9 | 1.5 | 27 | 82 |
| Comparative Example 15-1 | Li | Co₄₄Sn₅₆ | 16 | 6 | 6.4 | 1.5 | 0.1 | 50 |
| Comparative Example 15-2 | Li | Co₄₄Sn₅₆ | 16 | 6 | 6.8 | 1.5 | 46 | 46 |

TABLE 16

| | Counter | Composition of | Carbon amount | Si Amount | | Half-width of | Ratio of volume | Capacity retention |
|---|---|---|---|---|---|---|---|---|
| | electrode | tin alloy | [wt %] | [wt %] | SiC/Si | tin alloy [°] | of void [%] | rate [%] |
| Example 16-1 | Na | Fe₂₄Sn₇₆ | 16 | 6.2 | 6.3 | 1.5 | 2.5 | 50 |
| Example 10-5 | Na | Fe₂₄Sn₇₆ | 16 | 6 | 5.9 | 1.5 | 5.2 | 64 |
| Example 16-2 | Na | Fe₂₄Sn₇₆ | 16 | 6.3 | 6.3 | 1.5 | 26 | 62 |
| Comparative Example 16-1 | Na | Fe₂₄Sn₇₆ | 16 | 5 | 6.2 | 1.5 | 0.3 | 20 |
| Comparative Example 16-2 | Na | Fe₂₄Sn₇₆ | 16 | 5.8 | 6.4 | 1.5 | 45 | 21 |

As shown in Tables 15 and 16, even when the negative electrode active material further comprised silicon carbide and metallic silicon, in the batteries of the Comparative Examples in which the ratio of the volume of the void was outside the range of the present disclosure, the capacity retention rate was lower than that of the batteries of the Examples.

TABLE 17

| | Counter | Composition of | Carbon amount | Si Amount | | Half-width of | Ratio of volume | Capacity retention |
|---|---|---|---|---|---|---|---|---|
| | electrode | tin alloy | [wt %] | [wt %] | SiC/Si | tin alloy [°] | of void [%] | rate [%] |
| Example 9-1 | Li | Co₄₄Sn₅₆ | 16 | 6.3 | 6.5 | 1.5 | 5.2 | 83 |
| Example 15-2 | Li | Co₄₄Sn₅₆ | 16 | 6.2 | 6.9 | 1.5 | 27 | 82 |
| Example 17-1 | Li | Co₄₄Sn₅₆ | 16 | 6.1 | 3.9 | 1.5 | 20 | 78 |
| Example 17-2 | Li | Co₄₄Sn₅₆ | 16 | 7.3 | 2.1 | 1.5 | 17 | 74 |
| Example 17-3 | Li | Co₄₄Sn₅₆ | 16 | 7.5 | 1.5 | 1.5 | 14 | 62 |
| Comparative Example 9-1 | Li | Co₄₄Sn₅₆ | 16 | 5.3 | 0.8 | 1.5 | 5.2 | 30 |
| Comparative Example 17-1 | Li | Co₄₄Sn₅₆ | 16 | 9.2 | 0.4 | 1.5 | 4.5 | 21 |

TABLE 18

| | Counter | Composition of | Carbon amount | Si Amount | | Half-width of | Ratio of volume | Capacity retention |
|---|---|---|---|---|---|---|---|---|
| | electrode | tin allov | [wt %] | [wt %] | SiC/Si | tin alloy [°] | of void [%] | rate [%] |
| Example 16-2 | Na | Fe₂₄Sn₇₆ | 16 | 6.3 | 6.3 | 1.5 | 26 | 62 |
| Example 18-1 | Na | Fe₂₄Sn₇₆ | 16 | 6.9 | 4.1 | 1.5 | 22 | 58 |
| Example 18-2 | Na | Fe₂₄Sn₇₆ | 16 | 7.8 | 2.4 | 1.5 | 18 | 52 |
| Example 18-3 | Na | Fe₂₄Sn₇₆ | 16 | 8.3 | 1.4 | 1.5 | 12 | 46 |
| Comparative Example 18-1 | Na | Fe₂₄Sn₇₆ | 16 | 9.7 | 0.7 | 1.5 | 4.3 | 23 |
| Comparative Example 10-2 | Na | Fe₂₄Sn₇₆ | 16 | 5 | 0.4 | 1.5 | 0.3 | 17 |

As shown in Tables 17 and 18, when the negative electrode active material further comprised silicon carbide and metal silicon, in the batteries of the Comparative Examples in which the SiC/Si peak intensity ratio was outside the range of the present disclosure, the capacity retention rate was lower than that of the batteries of the examples.

### <<Manufacturing Example 3>><Production of Negative Electrode Active Material>

### (Composite Material Manufacturing Step)

A composite material was obtained in the same manner as in Manufacturing Example 1, except that the total mass of the raw materials was 15 g and the treatment by mechanical alloying was carried out at a rotation speed of 250 rpm for 28 hours.

### (Negative Electrode Active Material Precursor Manufacturing Step)

A negative electrode active material precursor was obtained in the same manner as in Manufacturing Example 1, except that silicon oxide (SiO₂) was used instead of silicon metal and the treatment by mechanical alloying was carried out at a rotation speed of 250 rpm for 2 hours.

### (Void Formation Step)

The obtained negative electrode active material precursor was brought into contact with an alkaline aqueous solution to elute SiO₂. Specifically, 3 g of the negative electrode active material precursor was immersed in 250 mL of 2M NaOH solution for 4 hour with stirring. After washing with 3L of ion-exchanged water and filtration, the solution was dried under vacuum at ordinary temperature. Thus, a powdery negative electrode active material was obtained.

### Example 19-1

The negative electrode active material of Manufacturing Example 3/AB/PVdF were weighed at a mass ratio of 80/15/5, and dispersed in NMP to prepare a slurry. This slurry was coated on a copper (Cu) current collector foil, pressed, and then vacuum dried overnight at 120° C. to obtain a negative electrode laminate as a test electrode. The positive electrode active material/AB/PVdF were weighed at a mass ratio of 85/10/5, and dispersed in NMP to prepare a slurry. This slurry was coated on an Al current collector foil, pressed, and then vacuum dried overnight at 120° C. to obtain a positive electrode laminate as a test electrode. These laminates were placed facing each other with a polypropylene separator between them, and were immersed in an electrolytic solution and sealed to prepare an evaluation cell. For the evaluation cell as a lithium-ion battery, nickel cobalt manganese oxide (NCM) was used as the positive electrode active material, and 1M LiPF₆ in EC/DMC/FEC was used as the electrolytic solution. For the evaluation cell as a sodium-ion battery, nickel iron manganese oxide (NiFeMn) was used as the positive electrode active material, and 1M NaPF₆ in EC/DEC was used as the electrolytic solution.

### <<Evaluation>>

### <Increase Amount of Confining Pressure>

The evaluation was carried out in a thermostatic chamber at 25° C., with a voltage range of 4.2V-2.5V and a 0.1 C rate. A load cell (manufactured by KYOWA, LCX-A-10KN) was inserted during charging and discharging, and charging was started at an initial pressure of 1 MPa. The increase amount of confining pressure during initial charging was divided by the charge capacity to calculate the increase amount of confining pressure per capacity. The increase amount of confining pressure means the amount of expansion of the negative electrode active material. The results are shown in Table 19.

Other evaluations were carried out in the same manner as above.

In this example, it was confirmed that the negative electrode active material contained SiO₂ from the change in the ratio of the carbon amount by infrared absorption method using EMIA-20E manufactured by HORIBA.

### Examples 19-2 to 19-5, Comparative Examples 19-1 to 19-5, and Reference Example 19-1

The batteries of each example were manufactured and evaluated in the same manner as in Example 19-1, except for changing the composition, carbon amount, half-width of tin alloy, and ratio of volume of void as shown in Table 19.

The increase amount of confining pressure for each of the above examples is shown in Table 19. In Table 19, the increase amount of confining pressure for the examples is shown as a relative value when the increase amount of confining pressure for the comparative example with the corresponding composition is set to 100.

In these examples, it was confirmed that the negative electrode active material contained SiO₂ from the change in the ratio of the carbon amount by infrared absorption method using EMIA-20E manufactured by HORIBA.

TABLE 19

| | Positive | | Carbon amount | Half-width of | Ratio of volume | Increase amount of |
|---|---|---|---|---|---|---|
| | electrode | Composition | [wt %] | tin alloy [°] | of void [%] | confining pressure [%] |
| Example 19-1 | Li | Co₄₅Sn₅₅ | 20 | 1.84 | 9.9 | 71 |
| Comparative Example 19-1 | Li | Co₄₅Sn₅₅ | 20 | 1.31 | 0.2 | 100 |
| Reference Example 19-1 | Li | Co₃₃Sn₆₇ | 0 | 0.26 | 0.2 | 117 |
| Example 19-2 | Li | Fe₄₃Sn₅₇ | 18 | 1.54 | 9.5 | 76 |
| Comparative Example 19-2 | Li | Fe₄₃Sn₅₇ | 18 | 1.21 | 0.2 | 100 |
| Example 19-3 | Li | Cu₅₁Sn₄₉ | 10 | 1.01 | 8.6 | 73 |
| Comparative Example 19-3 | Li | Cu₅₁Sn₄₉ | 10 | 1.05 | 0.2 | 100 |
| Example 19-4 | Na | Co₃₈Sn₆₂ | 19 | 1.67 | 9.3 | 82 |
| Comparative Example 19-4 | Na | Co₃₈Sn₆₂ | 19 | 1.11 | 0.2 | 100 |
| Example 19-5 | Na | Fe₃₇Sn₆₃ | 18 | 1.34 | 9.1 | 82 |
| Comparative Example 19-5 | Na | Fe₃₇Sn₆₃ | 18 | 1.07 | 0.2 | 100 |

As shown in Table 19, in the batteries of the examples in which the carbon amount, half-width of tin alloy, and ratio of volume of void were within the ranges of this disclosure, the increase amount of confining pressure, i.e., the amount of expansion of the negative electrode active material, was small.

### Examples 20-1 to 20-4

In particular, except that the ratio of volume of void was changed as shown in Table 20, the batteries of each example were manufactured and evaluated in the same manner as in Example 19-1.

The increase amount of confining pressure for each of the above examples is shown in Table 20. In Table 20, the increase amount of confining pressure for each example is shown as a relative value when the increase amount of confining pressure for Comparative Example 19-1 is set to 100.

TABLE 20

| | Positive | | Carbon amount | Half-width of | Ratio of volume | Increase amount of |
|---|---|---|---|---|---|---|
| | electrode | Composition | [wt %] | tin alloy [°] | of void [%] | confining pressure [%] |
| Comparative Example 19-1 | Li | Co₄₅Sn₅₅ | 20 | 1.31 | 0.2 | 100 |
| Example 20-1 | Li | Co₄₅Sn₅₅ | 20 | 1.75 | 2.6 | 90 |
| Example 19-1 | Li | Co₄₅Sn₅₅ | 20 | 1.84 | 9.9 | 71 |
| Example 20-2 | Li | Co₄₅Sn₅₅ | 20 | 1.89 | 15.0 | 65 |
| Example 20-3 | Li | Co₄₅Sn₅₅ | 20 | 1.91 | 22.0 | 59 |
| Example 20-4 | Li | Co₄₅Sn₅₅ | 20 | 1.90 | 33.0 | 58 |

As shown in Table 20, in the batteries of the examples in which the ratio of volume of void was within the range of this disclosure, the increase amount of confining pressure, i.e., the amount of expansion of the negative electrode active material, was small.

### DESCRIPTION OF REFERENCE SIGNS

10 Negative electrode active material
11 Carbon material
12 Tin alloy
13 Metallic silicon
14 Void
100 Secondary battery
110 Negative electrode current collector
120 Negative electrode active material layer
130 Separator
140 Positive electrode active material layer
150 Positive electrode current collector

1. A negative electrode active material, wherein
the negative electrode active material comprises a composite material containing a carbon material and a tin alloy,
the tin alloy is an alloy containing tin, and a metal selected from at least one of cobalt, iron, copper, and nickel,
an amount of the carbon material is 10% by mass or more and 30% by mass or less,
a half-width of the tin alloy in XRD spectrum is 0.3° or more, and
the negative electrode active material has a void of 0.5% by volume or more and 40% by volume or less.

2. The negative electrode active material according to claim 1, wherein
the negative electrode active material further comprises silicon carbide and metallic silicon, an amount of the metallic silicon is 0.1% by mass or more and 15% by mass or less, and
in XRD spectrum, a ratio of a peak intensity of the silicon carbide relative to a peak intensity of the metallic silicon is 1.0 or more.

3. The negative electrode active material according to claim 1, wherein the negative electrode active material further comprises silicon oxide.

4. A negative electrode mixture comprising the negative electrode active material according to claim 1.

5. A secondary battery, wherein
the secondary battery comprises a negative electrode active material layer, and
the negative electrode active material layer contains the negative electrode mixture according to claim 4.

6. A method for manufacturing a negative electrode active material according to claim 1, comprising the following steps:
mixing the carbon material, the tin, and the metal by a mechanical alloying method to obtain the composite material;
mixing the composite material, and a metallic silicon and/or a silicon oxide by a mechanical alloying method to obtain a negative electrode active material precursor; and
contacting the negative electrode active material precursor with an alkaline aqueous solution to elute the metallic silicon and/or the silicon oxide, thereby forming the void.
